(19) United States
(12) Patent Application Publication
(10) Pub. No.: US 2026/0024326 A1
(43) Pub. Date: Jan. 22, 2026

(54) APPARATUS AND COMPUTER-IMPLEMENTED METHOD FOR PROCESSING SENSOR DATA

(71) Applicant: Robert Bosch GmbH, Stuttgart (DE)

(72) Inventor: Tim Lucca Tarsi, Marbach (DE)

(21) Appl. No.: 19/274,995

(22) Filed: Jul. 21, 2025

(30) Foreign Application Priority Data
Jul. 22, 2024 (EP) 24 19 0112.3

(51) Int. Cl. G06V 10/82; G06F 17/14; G06V 10/77

(52) U.S. Cl. CPC G06V 10/82; G06F 17/142; G06V 10/77

(57) ABSTRACT

A device and a computer-implemented method for processing sensor data. The sensor data are divided into parts and the parts of the sensor data are each mapped to a representation, in particular a tensor. For each representation a weighting assigned to the representation is determined depending on the representation, which weighting characterizes an information content of the part of the sensor data represented by the representation. Weightings are drawn from a distribution of the weightings determined for the representation. A classification and/or regression of the sensor data are determined depending on the representations assigned to the drawn weightings.

### FIELD

The present invention is based on an apparatus and a computer-implemented method for processing sensor data.

### BACKGROUND INFORMATION

The processing of sensor data is required for a variety of applications.

### SUMMARY

For the classification or regression of sensor data, even before classification or regression, it is advantageous to reduce an amount of the sensor data to be processed.

According to an example embodiment of the present invention, a computer-implemented method for processing sensor data provides that the sensor data are divided into parts and the parts of the sensor data are each mapped to a representation, in particular a tensor, wherein for each representation a weighting assigned to the representation is determined depending on the representation, which weighting characterizes an information content of the part of the sensor data represented by the representation, wherein weightings are drawn from a distribution of the weightings determined for the representations, wherein a classification and/or regression of the sensor data are determined depending on the representations assigned to the weightings drawn. The weightings incorporate heuristic knowledge about the sensor data into the selection of the parts. The amount of sensor data to be processed is reduced by means of the weightings to relevant parts of the sensor data according to the heuristic knowledge. This speeds up the processing of sensor data compared to the processing of all parts.

According to an example embodiment of the present invention, for sensor data without a channel or for sensor data from a channel, it can be provided that absolute values of Fourier coefficients of a discrete fast Fourier transform of the representation are determined for each representation, wherein the weighting per representation is determined depending on an entropy of a distribution of the absolute values. The size of the absolute values quantifies the introduced heuristic knowledge proportionally to the information content of the part in question.

According to an example embodiment of the present invention, it can be provided that the sensor data are divided into a plurality of channels, wherein the respective representation comprises a vector for each channel, wherein the sensor data of the respective part are mapped channel by channel to a vector of the representation assigned to the respective channel, wherein for each representation and each channel a weighting is determined which characterizes an information content of the part of the sensor data represented by the vector, wherein the weighting characterizing the information content of the part of the sensor data represented by the representation is determined as a function of the weightings determined for the vectors of the representation, in particular as a function of an average value of the weightings determined for the vectors of the representation.

According to an example embodiment of the present invention, for the sensor data divided into a plurality of channels, it can be provided that for each vector absolute values of Fourier coefficients of a discrete fast Fourier transform of the vector are determined, wherein for each vector the weighting is determined depending on an entropy of a distribution of the absolute values. The size of the absolute values per vector quantifies the introduced heuristic knowledge proportionally to the information content of the respective channel of the respective part.

For the sensor data divided into a plurality of channels, it can be provided that for each representation, main directions of the representation are determined by means of a principal component analysis, wherein the weighting is determined depending on a total variance of the representation with respect to the main directions. For example, the principal component analysis is performed for the points defined by the vectors of the respective channels.

According to an example embodiment of the present invention, it can be provided that temporally and/or spatially adjacent parts of the sensor data are mapped to mutually adjacent representations, wherein for each representation Fourier coefficients of a discrete fast Fourier transform of the representation are determined, wherein the weighting per representation is determined depending on a similarity of the Fourier coefficients of the respective representation to the Fourier coefficients of at least one representation adjacent to the respective representation. The magnitude of the similarity quantifies the introduced heuristic knowledge inversely proportionally to the information content. This means that the more similar the Fourier coefficients are to each other, the lower the information content of the part as compared to at least one adjacent part.

In one example, a digital image is provided, in particular a video image, a radar image, lidar image, an ultrasound image, a motion detector image, or an infrared image, wherein the image comprises the sensor data, in particular divided into the plurality of channels, wherein the image is divided into a grid with grid cells, wherein each grid cell comprises one of the parts of the sensor data. This means that in the method the sensor data from the digital image are processed.

The digital image comprises, for example, a set of pixels, wherein for each pixel from the set of pixels, a plurality of channels are defined, each with a pixel value, wherein the parts of the sensor data each comprise a subset of the set of pixels, wherein for each subset the pixel values are mapped to the tensor, in particular to a vector for the multiple channels or to a matrix, wherein the matrix comprises a vector for each channel of the multiple channels.

According to an example embodiment of the present invention, the method may provide that an artificial neural network is trained for the classification or regression of the sensor data depending on the representations associated with the drawn weightings. In a transform-based artificial neural network, the representations associated with the drawn weightings are processed successively. The representations and/or the weightings can be calculated successively or at least partially in parallel.

According to an example embodiment of the present invention, an apparatus for processing data comprises at least one processor and at least one memory, wherein the at least one memory contains instructions executable by the at least one processor, upon whose execution by the at least one processor, the apparatus carries out the method of the present invention.

According to an example embodiment of the present invention, a computer program comprises instructions that can be executed by a computer and, when executed by the computer cause the method of the present invention to run on the computer.

Further advantageous embodiments can be found in the following description and the figures.

### BRIEF DESCRIPTION OF THE DRAWINGS

FIG. 1 is a schematic representation of an apparatus for processing sensor data, according to an example embodiment of the present invention.

FIG. 2 shows a flow chart with steps of a method for processing the sensor data, according to an example embodiment of the present invention.

FIG. 3 shows a first example of a digital image and parts of the digital image determined in the method, according to the present invention.

FIG. 4 shows a second example of a digital image and parts of the digital image determined in the method, according to the present invention.

FIG. 5 shows a third example of a digital image and parts of the digital image determined in the method, according to the present invention.

### DETAILED DESCRIPTION OF EXAMPLE EMBODIMENTS

FIG. 1 schematically shows an apparatus 100 for processing sensor data.

The apparatus 100 comprises at least one processor 102 and at least one memory 104.

The at least one memory 104 comprises instructions executable by the at least one processor 102, upon the execution of which by the at least one processor 102, the apparatus 100 carries out a method described below.

It is possible to provide a computer program that comprises instructions that are executable by a computer and that, when executed by the computer, cause the method to run on the computer.

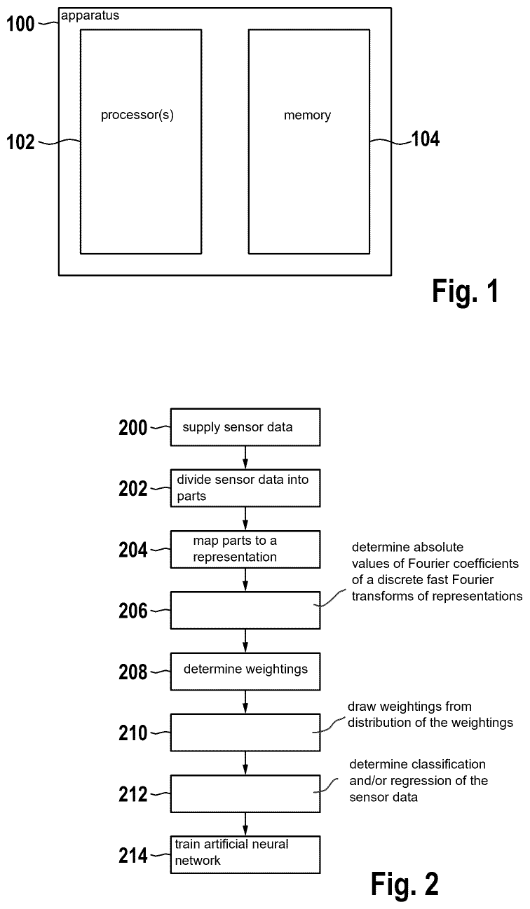

FIG. 2 shows a flow chart with steps of the method.

The method comprises a step 200.

In step 200, sensor data are supplied. In the example, the sensor data are assigned to a plurality of different channels.

The method is independent of the type of sensor that provides the sensor data. Preprocessing of the sensor data may be provided. For example, the sensor data are processed to minimize any noise that may occur. For example, high-frequency interference, which could later influence the distribution of the Fourier coefficients, is removed from the sensor data by preprocessing. This removes any interference that could distort the final result.

For example, the preprocessing includes an antialiasing filter.

In the example, a digital image is provided. The digital image includes the sensor data. The image is an RGB image, for example. In the example, the channels are color channels of the image. The digital image contains a number of pixels. For each pixel from the set of pixels, a plurality of channels are defined, each with a pixel value. The pixel values are, for example, values from 0 to 255.

The digital image will be specified, for example, in a data format, e.g. JPEG format. The JPEG format usually causes the high frequency ranges of the noise to be lost due to compression. In this case, preprocessing of the sensor data from the image in JPEG format can be omitted. Preprocessing takes place, for example, in the case of a digital image that is not compressed or not preprocessed.

The sensor data can be supplied without a channel. The sensor data can be provided assigned to only one channel, e.g. in a monochrome image.

The image can be a video image, a radar image, a LiDAR image, an ultrasound image, a motion detector image, or an infrared image.

The method comprises a step 202.

In step 202, the sensor data are divided into parts.

In the example, the image is divided into a grid with grid cells. In the example, each grid cell contains one of the parts of the sensor data.

This means that the parts of the sensor data each contain a subset of the set of pixels.

The method comprises a step 204.

In step 204, the parts of the sensor data are each mapped to a representation.

In the example, the representation is a tensor.

In the example, for each subset the pixel values are mapped to the tensor.

It can be provided that the tensor is a vector, with the pixel values being mapped to a vector for the multiple channels.

It can be provided that the tensor is a matrix, wherein the matrix comprises a vector for each of the multiple channels to which the pixel values of the respective channel are mapped.

In the example, the sensor data are divided into a plurality of channels. This means that the respective representation comprises one vector per channel. This means that the sensor data of the respective part are mapped channel by channel to a vector of representation assigned to the respective channel.

In the example, sensor data x are mapped to representations \tilde{x}[n]:

$$x ∈ {ℝ}^{H \times W \times C} \to \tilde{x} [ n ] ∈ {ℝ}^{N \times {CP}^{2}}$$

where H is the height, W is the width, C is the number of channels, N is the number of parts, and P is the dimensions of the grid cells, i.e. of the two-dimensional part, which are identical in the example. In the example, a kernel of dimension P×P is used to map the respective part.

The method comprises a step 206.

In step 206, absolute values of Fourier coefficients of a discrete fast Fourier transform of the representation are determined for each representation.

This means that in the example, the absolute values of Fourier coefficients of a discrete fast Fourier transform of the vector are determined for each vector.

In the example, a fast Fourier transform is determined for each channel:

$$\tilde{X} [ n , c , k ] = {\sum }_{i = 0}^{N - 1} \tilde{x} [ n , c , i ] {e}^{- j ( \frac{2 π}{N} ) k n}$$

The method comprises a step 208.

In step 208, a weighting is determined for each representation that characterizes an information content of the part of the sensor data represented by the representation.

In the example, the weighting per representation is determined depending on an entropy of a distribution of the absolute values. In the example, the weighting of each vector is determined depending on the entropy of the distribution of the absolute values determined for the vector.

In the example, the entropy

$$H [ \tilde{x} [ n ] ] = - \frac{1}{\vert C \vert} {\sum }_{c , k} \tilde{X} [ n , c , k ] log ( \tilde{X} [ n , c , k ] )$$

is determined.

This means that in the example, a weighting is determined for each representation and each channel, which weighting characterizes an information content of the part of the sensor data represented by the vector. The weighting for the respective representation is determined depending on the weightings determined channel-wise, i.e. per vector of the matrix, for the respective representation. For example, the weighting for the respective representation depends on an average of the channel-by-channel weightings determined for the representation.

In the example, for the representations \tilde{x}[n] weightings w[n] are determined:

$$\tilde{x} [ n ] ∈ {ℝ}^{N \times {CP}^{2}} \to w [ n ] ∈ {ℝ}^{N}$$

This results in a distribution of the weightings determined for the representations.

The method comprises a step 210.

In step 210, weightings are drawn from a distribution of the weightings determined for the representations. In the example, a prespecified number of weightings are drawn from the distribution. By the selection of the number, a prespecified proportion of the parts of the sensor data is used and the other parts are omitted. This corresponds to a drop-out rate.

The method may provide for asking a user for the number. The number can be a number defined in advance, in particular by a user.

In the example, P is drawn from a distribution:

$$\tilde{x} [ n ] ∼ P with P [ k ] = \frac{w [ k ]}{{\sum }_{i} w [ i ]}$$

The method comprises a step 212.

In step 212, a classification and/or regression of the sensor data are determined depending on the representations associated with the drawn weightings.

For training purposes, the method may provide that steps 200 to 212 are carried out for different sensor data, in particular different images. To train a classifier, a reference value for the classification is assigned to the respective sensor data, for example. To train a regression model, a reference value for the regression is assigned to the respective sensor data, for example.

For training, the method may include a step 214.

In step 214, for example, an artificial neural network is trained depending on the representations of the respective sensor data assigned to the drawn weightings and on the reference for classification assigned to the respective sensor data. In step 214, for example, an artificial neural network is trained depending on the representations of the respective sensor data assigned to the drawn weightings and on the reference for regression assigned to the respective sensor data.

In step 204, the representations can be determined successively or at least partially in parallel in time. In step 206, the Fourier coefficients can be determined successively or at least partially in parallel in time.

The determination at least partially in parallel over time accelerates the process overall. The successive determination requires more computing time and requires fewer other computing resources, such as memory or computing power, than the determination at least partially in parallel over time.

Instead of determining the weightings depending on the Fourier coefficients, it can be provided that for each representation, main directions of the representation are determined using a principal component analysis. The weighting of the respective representation is determined, for example, depending on a total variance of the representation with respect to the main directions.

Instead of determining the weightings depending on the Fourier coefficients of a representation, it can be provided that temporally and/or spatially adjacent parts of the sensor data are mapped to representations that are marked as adjacent representations. For each representation, the weighting is determined, for example, depending on a similarity of the Fourier coefficients of the respective representation to the Fourier coefficients of at least one representation adjacent to the respective representation.

For example, the weighting w[n] for four grid cell m adjacent to a grid cell n in the x- and y-direction, depending on a respective representation \tilde{x}[m] of the adjacent grid cell m and depending on the representation \tilde{x}[n] of the grid cell n, is determined,

$$w [ n ] = \frac{1}{\vert N ( \tilde{x} [ n ] ) \vert} {\sum }_{\overline{x} [ m ] ∈ N ( \overline{x} [ n ] )} S ( \tilde{x} [ n ] , \tilde{x} [ m ] )$$

$$where$$

$$S ( \tilde{x} [ n ] , \tilde{x} [ m ] ) := JSD ( \tilde{x} [ n ] , \tilde{x} [ m ] ) = \frac{1}{2} {D}_{KL} ( \tilde{x} [ n ] \vert \tilde{x} [ m ] ) + \frac{1}{2} {D}_{KL} ( \tilde{x} [ m ] \vert \tilde{x} [ n ] )$$

and JSD represents the Jensen-Shannon divergence and D_{KL} represents the Kulback-Leibler divergence.

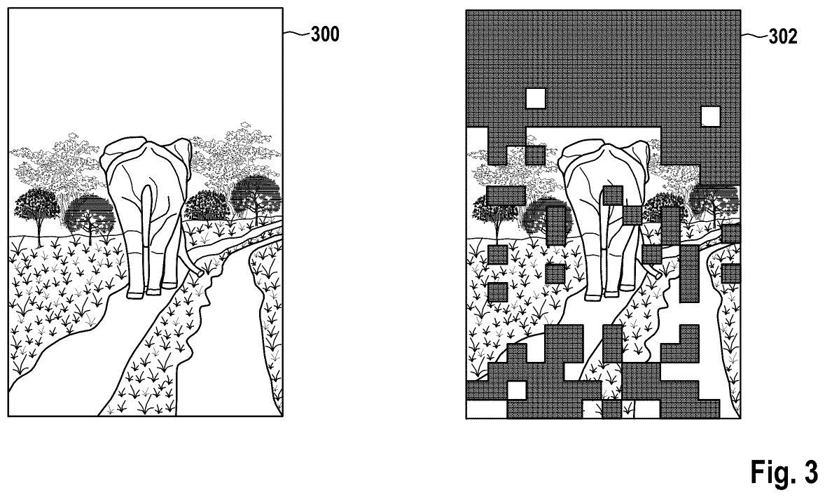

FIG. 3 shows a first example 300 of a digital image on the left and on the right a first example 302 of the parts of the digital image that are used for classification or regression. Unused parts of the image according to the first example 300 are shown in black in FIG. 3. The digital image according to the first example 300 is from the natural domain.

For example, the method is a method for object recognition in which digital images from the natural domain are processed to determine the classification, wherein the classification includes the object recognized. The device 100 is, for example, an object recognition device configured to process a digital image from the natural domain for classification or regression.

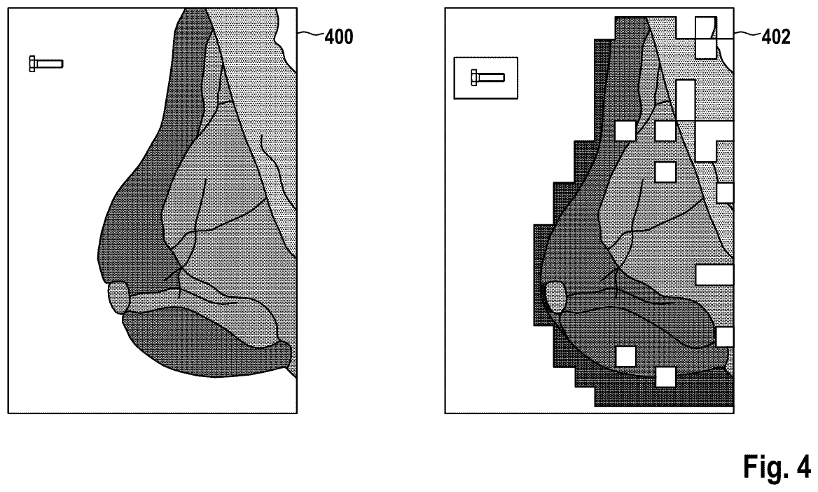

FIG. 4 shows a second example 400 of the digital image on the left and on the right a second example 402 of the parts of the digital image used for classification or regression. Unused parts of the image according to the second example 400 are shown in white in FIG. 4. The digital image according to the first example 300 is from the medical domain.

For example, the method is a diagnostic method in which digital images from the medical domain are processed to determine the classification, wherein the classification includes the diagnosis. The device 100 is, for example, a medical device for diagnosis that is designed to process a digital image from the medical domain for classification or regression.

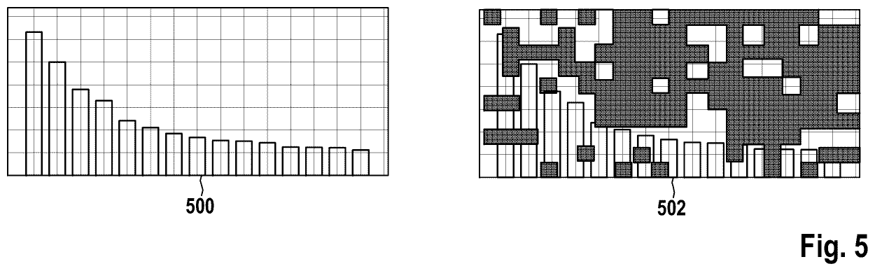

FIG. 5 shows a third example 500 for a digital image on the left and on the right a third example 502 for the parts of the digital image used for classification or regression. Unused parts of the image according to the third example 500 are shown in black in FIG. 5. The digital image according to the first example 300 is from the domain of science.

1-12. (canceled)

13. A computer-implemented method for processing sensor data, the method comprising the following steps:
dividing the sensor data into parts;
mapping each of the parts of the sensor data to a representation including a tensor;
determining, for each of the representations, a weighting assigned to the representation, depending on the representation, the weighting characterizing an information content of the part of the sensor data represented by the representation;
drawing weightings from a distribution of the weightings determined for the representations; and
determining a classification and/or regression of the sensor data depending on the representations assigned to the drawn weightings.

14. The method according to claim 13, wherein, for each of the representations, absolute values of Fourier coefficients of a discrete fast Fourier transform of the representation are determined, wherein the weighting per representation is determined as a function of an entropy of a distribution of the absolute values.

15. The method according to claim 13, wherein the sensor data are divided into a plurality of channels, wherein the representation of each of the parts of the sensor data includes a vector for each channel, wherein the sensor data of the each part are mapped channel by channel to a vector of the representation assigned to the respective channel, wherein a weighting is determined for each representation and each channel, the weighting characterizing an information content of the part of the sensor data represented by the vector, wherein the weighting characterizes the information content of the part of the sensor data represented by the representation is determined as a function of the weightings determined for the vectors of the representation, the function including a function of an average value of the weightings determined for the vectors of the representation.

16. The method according to claim 15, wherein, for each vector absolute values of Fourier coefficients of a discrete fast Fourier transform of the vector are determined, wherein for each vector, the weighting is determined as a function of an entropy of a distribution of the absolute values.

17. The method according to claim 15, wherein, for each representation, main directions of the representation are determined using a principal component analysis, the weighting being determined as a function of a total variance of the representation with respect to the main directions.

18. The method according to claim 13, wherein temporally and/or spatially adjacent parts of the sensor data are mapped to mutually adjacent representations, wherein for each representation, Fourier coefficients of a discrete fast Fourier transform of the representation are determined, wherein the weighting for each representation is determined depending on a similarity of the Fourier coefficients of the representation to the Fourier coefficients of at least one representation adjacent to the representation.

19. The method according to claim 13, wherein a digital image, including a video image or a radar image or a lidar image or an ultrasound image or a motion detector image or an infrared image, is provided, wherein the image includes the sensor data, divided into a plurality of channels, wherein the image is divided into a grid with grid cells, wherein each grid cell includes one of the parts of the sensor data.

20. The method according to claim 19, wherein the digital image includes a set of pixels, wherein for each pixel from the set of pixels, a plurality of channels are defined, each with a pixel value, wherein the parts of the sensor data each include a subset of the set of pixels, wherein for each subset the pixel values are mapped to the tensor, the tensor being a vector for the plurality of channels or a matrix including a vector for each channel of the plurality of channels.

21. The method according to claim 13, wherein, the classification or regression of the sensor data, an artificial neural network is trained depending on the representations assigned to the drawn weightings.

22. The method according to claim 13, wherein the representations and/or the weightings are determined successively or at least partially parallel to one another over time.

23. An apparatus for classifying data, comprising:
at least one processor; and
at least one memory, wherein the at least one memory includes instructions executable by the at least one processor, upon the execution of which by the at least one processor, the apparatus carries out a method for processing sensor data, the method comprising the following steps:
dividing the sensor data into parts,
mapping each of the parts of the sensor data to a representation including a tensor,
determining, for each of the representations, a weighting assigned to the representation, depending on the representation, the weighting characterizing an information content of the part of the sensor data represented by the representation,
drawing weightings from a distribution of the weightings determined for the representations, and
determining a classification and/or regression of the sensor data depending on the representations assigned to the drawn weightings.

24. A non-transitory computer-readable medium on which is stores a computer program including instructions for processing sensor data, the instructions, when executed by a computer, causing the computer to perform the following steps:
dividing the sensor data into parts;
mapping each of the parts of the sensor data to a representation including a tensor;
determining, for each of the representations, a weighting assigned to the representation, depending on the representation, the weighting characterizing an information content of the part of the sensor data represented by the representation;
drawing weightings from a distribution of the weightings determined for the representations; and
determining a classification and/or regression of the sensor data depending on the representations assigned to the drawn weightings.
